(19) United States
(12) Patent Application Publication
(10) Pub. No.: US 2004/0178025 A1
(43) Pub. Date: Sep. 16, 2004

(54) Pushchair with separate brake locking and unlocking means placed in proximity to each other

(75) Inventor: Bruno Zweideck, Cholet (FR)

Correspondence Address: Robert M. Angus, Westman, Champlin & Kelly, Suite 1600, 900 Second Avenue South, Minneapolis, MN, 55402-3319, US

(73) Assignee: AMPAFRANCE, Cholet (FR)

(21) Appl. No.: 10/777,485

(22) Filed: Feb. 12, 2004

(30) Foreign Application Priority Data
Feb. 12, 2003 (FR) FR 03 01700

(51) Int. Cl. B62M 1/14

(52) U.S. Cl. 188/2 F; 280/250.1

(57) ABSTRACT

A pushchair comprises a frame carried by at least three wheels, at least two of the wheels being mounted on opposite sides of the frame. Locking/unlocking means on each of the two wheels are connected to each other so as to act simultaneously. The Locking/unlocking means is characterized by locking control means and unlocking control means distinct from the locking control means. The locking control means and the unlocking control means being mounted in proximity to one and the same wheel.

### FIELD OF THE INVENTION

The field of the invention is that of infant care, and to be more precise perambulators (hereinafter called “pushchairs”, this term here encompassing all infant care devices fitted with wheels and allowing one or more children to be transported). To be even more precise, the invention relates to the means for locking/unlocking wheels, and their associated control, used when the pushchair is parked.

### BACKGROUND OF THE INVENTION

Pushchairs have, more often than not, four wheels, or wheel blocks, mounted respectively at the connection branch end of the pushchair frame or at the ends of a transverse axis mounted to rotate freely on the frame.

Three-wheel pushchairs have also been proposed.

Whether they have four or three wheels (or wheel blocks), pushchairs are generally designed so as to have at the rear, (on the handlebar side), at least two wheels distributed on either side of the longitudinal axis of the pushchair. One or more of these wheels is often provided with locking means with a view to ensuring that the pushchair is immobilised when it is parked, comprising when it is placed on sloping ground.

To ensure satisfactory immobilisation, it has been proposed to lock at least both rear wheels (or wheel blocks) (on the handlebar side) rather than just one of them. Indeed when only one of the wheels is locked, the pushchair could easily, in certain conditions, pivot round on this wheel.

To avoid this phenomenon, pushchairs have therefore been proposed fitted with a locking/unlocking device that acts simultaneously on two wheels set apart from each other.

According to one particular technique of implementing this approach, provision is made for an actuating device to be placed near each wheel of the associated brake mechanism, one to ensure locking and the other to ensure unlocking.

To be more precise, the two actuating devices are connected to each other, and to the locking/unlocking mechanisms, so that the two locking/unlocking mechanisms are gripped (immobilised pushchair) when a first actuating device is actuated and the two locking/unlocking mechanisms are released when the other actuating device is actuated.

It will be understood therefore that it is necessary to provide means for connecting the actuating devices to each other, and means for connecting each of the actuating devices to the locking/unlocking mechanisms.

Each actuating device must consequently act not only on the locking/unlocking mechanisms, but also on the other actuating device.

The unit therefore forms a complex unit, which may prove long and tedious to assemble and adjust, a fact which obviously has an impact on the cost of the pushchair.

Furthermore, if this approach is of aesthetic interest, (the two distributed controls have the same appearance, which allows visual symmetry to be retained), it is not very ergonomic, since the symmetry often introduces confusion in the mind of the user who no longer knows which control is for braking or unlocking.

The particular objective of the invention is to overcome the drawbacks of the prior art.

To be more precise, the objective of the invention is to propose a pushchair fitted with easily employable means for simultaneously locking/unlocking two wheels.

In this sense, the particular objective of the invention is to provide a pushchair of this kind in which the wheel locking/unlocking device is more straightforward to mount and/or to adjust than prior art solutions.

Another objective of the invention is to provide a pushchair of this kind in which the actuating devices for locking and unlocking the wheels are ergonomic, and in particular easy to use.

Another objective of the invention is to provide a pushchair of this kind that has a wheel locking/unlocking device that is reliable and durable, and not prone to damage due to possible bumps or fouling.

### SUMMARY OF THE INVENTION

These objectives as well as others which will emerge subsequently are met thanks to the invention, the subject of which is a pushchair of the type comprising a frame carried by at least three wheels, at least two of the wheels being mounted on either side of the frame, locking/unlocking means being provided on each of the two wheels and being connected to each other so as to act simultaneously. The pushchair comprises on the one hand locking control means and on the other hand unlocking control means, distinct from the locking control means, the locking control means and the unlocking control means being mounted in proximity to one and the same wheel.

Unlike the prior art, the locking actuating devices and those in respect of unlocking are brought together in proximity to one and the same wheel, while remaining separated from each other.

The need is therefore obviated for multiple remote connection means for the operational components, leading to a significant simplification of the assembly and/or the adjustment of the locking/unlocking device, which leads to a reduction in its costs. The risks of confusion between the controls are also avoided.

According to one preferred solution, the pushchair comprises means for retaining the locking control means in the locked position, the unlocking control means acting on the retention means with a view to unlocking the wheels.

In this way, one of the two control means acts directly on the locking means, which considerably simplifies the whole device.

The unlocking control means act only on the retention means to release the pushchair from its locking position.

These different means being, according to the invention, directly in proximity to each other, the unlocking control means act directly on the retention means, without it being necessary to provide transmission or connection means.

Moreover, control of the “memory effect” type is obtained. In other words, once the locking control is activated, the brake is activated and remains in the locking position. Such a control is therefore particularly practical to use.

According to one preferred solution, the retention means engage with means for transmitting the locking/unlocking of the wheel in proximity to which the locking control means and the unlocking control means are mounted to the second of the two wheels.

In this way the locking control is transmitted simply and effectively to the second wheel concerned, with a view to locking the two wheels simultaneously or almost.

In this case, the transmission means act on a second pivoted lever mounted in proximity to the second wheel, the second pivoted lever carrying at least one lug able to mesh with at least one tooth wheeled integral with the axis of rotation of the second wheel with a view to locking it.

The wheel locking mechanism not carrying the control means appears therefore to be of similar design and operation to that described for the wheel carrying the control means.

The corresponding varieties of assembly may consequently be presented in similar ways.

Preferentially, the pushchair comprises a first pedal having at least one locking catch intended to engage with the locking position retention means, and a second pedal which, when it is activated, disengages the locking catch from the retention means.

A mechanism of simple and effective design is thus obtained that is very practical and ergonomic to use, with one specific pedal being clearly used for locking while the other is used for unlocking the wheels.

Moreover, as will appear more clearly below, unlocking and locking can be achieved by one straightforward, indeed natural action, consisting in pressing (by means of the foot or the hand) a button or a pedal.

The fact of being able to unlock by pressing proves advantageous when set against some prior art solutions, according to which the foot has to be passed under the pedal, the latter then being moved or pivoted upwards to achieve unlocking. These conventional solutions in fact generate several regrettable consequences:

pedals of this type cause wear, or even damage, to shoes, since they are activated with the upper side of the shoe tip (in order to apply a bottom up force); in fact, shoes are not generally expected to bear a potentially repetitive contact of this kind and the leather or material of which they are made can be damaged by the pedal;

the contact of the pedal on the foot may prove unpleasant, indeed painful, in particular when the user is wearing open or light shoes.

To advantage the locking control means are combined with recall means tending to return the locking control means into the unlocking position.

The user thus has help in unlocking the wheels of the pushchair when he activates the relevant pedal.

Preferentially, the retention means comprise a pivoted lever that has an indentation forming a housing for the catch of the first pedal.

In this case, the pivoted lever is able to carry means of locking the wheel in proximity to which the locking control means and the unlocking control means are mounted.

The lever has in this way a dual function, that of maintaining the locking position of the relevant pedal and that of directly ensuring the locking of the corresponding wheel.

Again, such an arrangement allows the number of employed parts to be reduced, and consequently its assembly to be simplified.

According to one advantageous solution, the pivoted lever carries at least one lug able to mesh with at least one toothed wheel integral with the axis of rotation of the wheel.

Preferentially, the first pedal is mounted to pivot on the frame.

Clearly, other embodiments are conceivable without departing from the framework of the invention, particularly by providing for example a mobile sliding locking pedal.

However, the pivoted pedal assembly has the advantage of being less fragile, particularly on account of the fact that it is to a lesser degree prone to potential fouling effects.

To advantage, the transmission means comprise at least one cable one end of which carries a stud held in a housing of the pivoted lever.

Again, such an arrangement allows the assembly to be considerably simplified and its duration to be reduced.

According to one advantageous characteristic, the second lever is combined with recall means tending to return it to the unlocking position.

The unlocking of the wheel carrying the control means is thus prevented from being constrained by the locking of the other wheel, particularly in the event of the latter's mechanism getting jammed.

According to another advantageous characteristic, the rear wheels and/or the front wheels are each carried by a clevis of cantilevered construction on the frame, in the absence of an axle between them.

It is thus possible to eliminate the cross tie conventionally mounted between the wheels of pushchairs, this cross tie having the effect of reducing the ground clearance of the pushchair.

Moreover, such an arrangement makes it possible to increase the pushchair's folding potential, in particularly folding into a “bundle”, in the absence of the cross tie between the wheels.

To advantage, the devises are preferentially mounted to slide freely on the corresponding connection branch of the frame or on a part integral with this connection branch, the pushchair comprising, according to a preferred solution, load damper means placed on the sliding path of the clevises relative to the connection branches or to the parts integral with them.

To advantage, the pushchair comprises a bushing for guiding the sliding of the clevis relative to the connection branch or the part integral with it, the bushing being preferentially integral with a shell enclosing the clevis at least partially.

In this case, the shell preferentially also encloses the locking means and/or supports the locking or unlocking control means.

The locking/unlocking mechanism is thus streamlined via the shell (which can consist of two half-shells assembled so as to make it easier to mount), which cuts down the risks of damage due to bumps or possible fouling.

To advantage, the damper means are mounted between the bushing or the shell and a truncated cone-shaped portion of the connection branch or of a part integral with it.

### BRIEF DESCRIPTION OF THE DRAWINGS

Other characteristics and advantages of the invention will emerge more clearly from reading the following description of one preferential embodiment of a pushchair according to the invention, given by way of example and non-respectively, and of the appended drawings among which:

FIG. 1 is an overall view of the pushchair wheel locking/unlocking device according to the invention;

FIGS. 2 and 4 are views of the locking/unlocking mechanism of the wheel carrying the control means, in the unlocked position and in the locked position respectively;

FIGS. 3 and 5 are views of the locking/unlocking mechanism of the wheel not carrying the control means, in the unlocked position and in the locked position respectively.

### DETAILED DESCRIPTION OF THE PREFERRED EMBODIMENTS

As mentioned previously, the principle of the invention is based on the implementation, in proximity to one and the same wheel, of the locking control means and of the unlocking control means, acting simultaneously on both wheels.

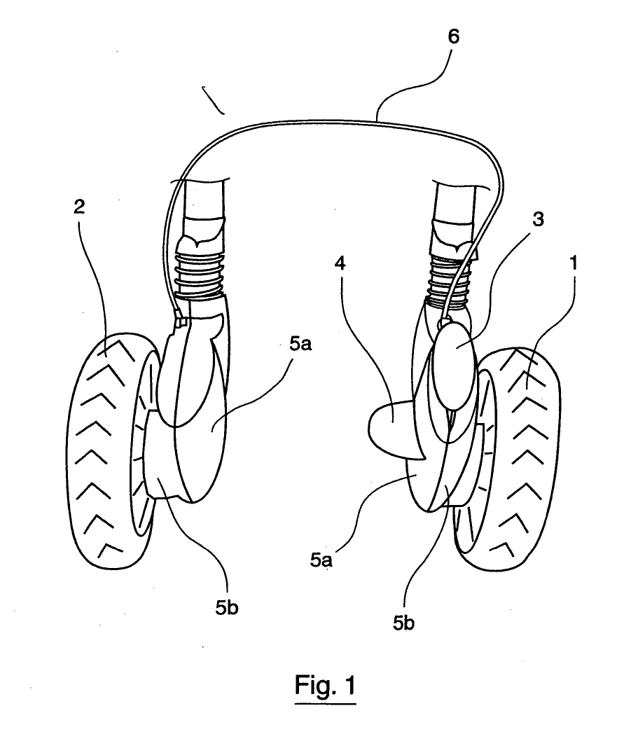

This approach appears clearly in FIG. 1 which shows a locking/unlocking device acting simultaneously on two wheels 1, 2 and comprising according to the invention, a pedal 3 for controlling the locking of the wheels 1 and 2 and a pedal 4 for controlling the unlocking, these pedals 3 and 4 being mounted in proximity to one and the same wheel 1.

According to the present embodiment, each of the locking/unlocking mechanisms is streamlined via two half-shells.

Locking and unlocking is achieved in a simultaneous way on the wheels 1 and 2, by connecting the mechanisms internal to the two half-shells 5a and 5b by a cable 6, as will be explained in more detail below.

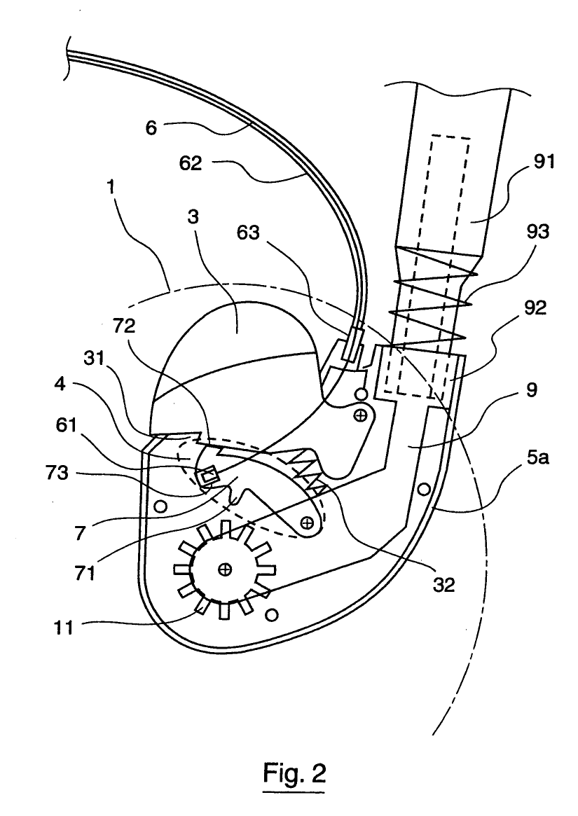

With reference to FIG. 2, the pedal 3 is mounted to pivot on one of the half-shells 5a so as to act, when it is activated, on a first lever 7 also pivoted and intended to ensure the locking of the wheel 1.

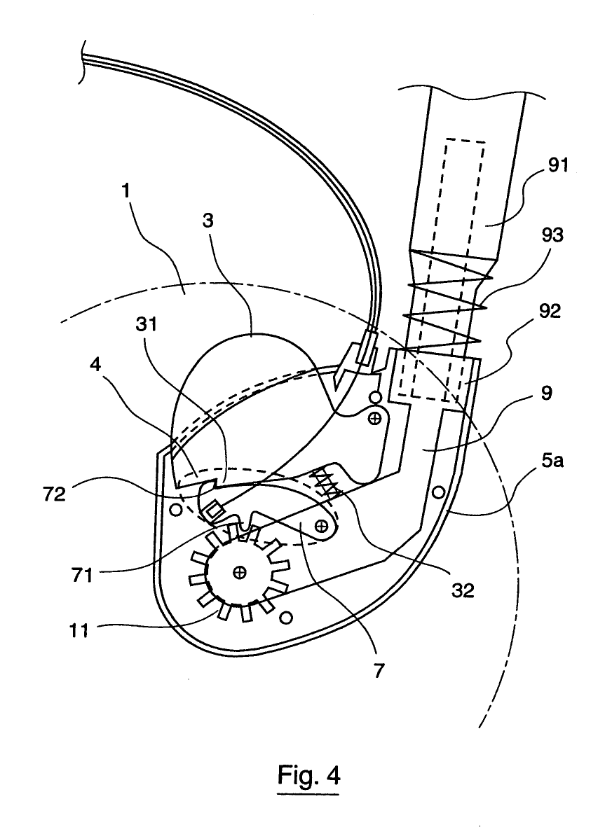

To do this, the lever 7 carries a lug 71 intended to mesh with a toothed wheel 11 integral in rotation with the axis of rotation of the wheel 1, the lever 7 engaging with this toothed wheel 11 so as to lock the wheel 1 in the manner shown in FIG. 4.

Furthermore, the lever 7 has an indentation 72 intended to engage with a catch 31 provided on the pedal 3 with a view to retaining it in the locking position, the lever 7 and the pedal 3 then occupying a position shown in FIG. 4.

Additionally, the lever 7 and the pedal 4 (appearing in dotted lines in FIGS. 2 and 4) are mounted relative to each other in such a way as to be anchored in rotation, the pedal 4 being intended, when it is activated, to disengage the catch 31 from the indentation 72 with a view to allowing the assembly to return to an unlocking position.

It is noted that the mechanism comprises a spring 32 combined with the pedal 3 in such a way that the spring 32 works in compression when the pedal 3 is activated.

Furthermore, transmission of the locking and unlocking controls of the wheels 1 and 2 between them is provided by a cable 6 as already mentioned. A first end of the cable carrying a stud 61 held in a housing 73 of the lever 7, and the other end of the cable also carrying a stud 62 held in a housing 81 of a lever 8 forming a means of locking the wheel 2.

This cable 6 is able to slide in a sheath 62 held at its ends in the corresponding half-shells by means of eyelets 63.

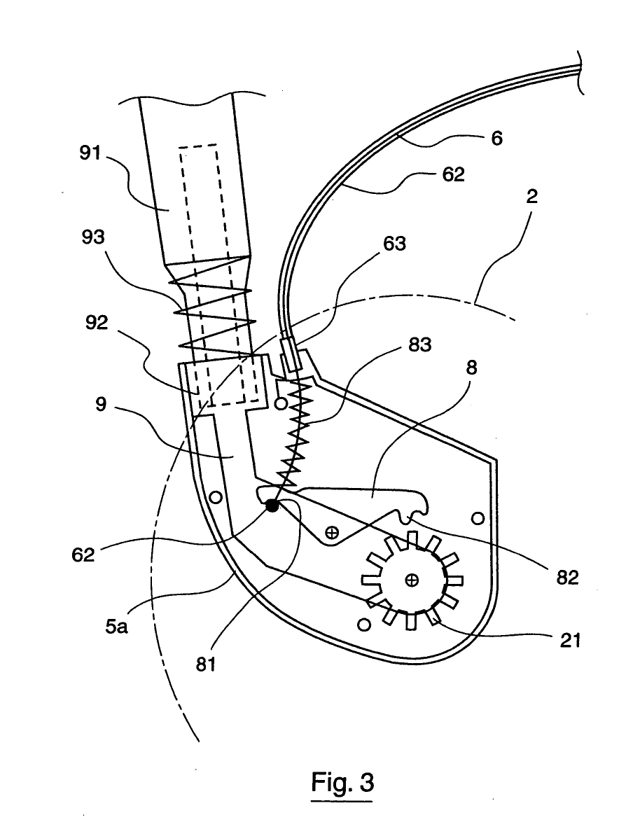

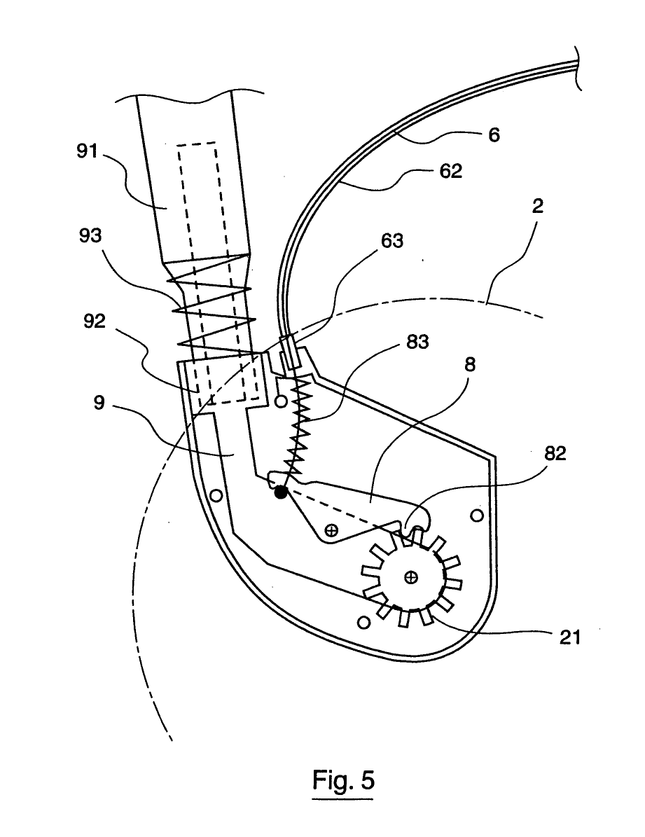

With reference to FIGS. 3 and 5, the locking/unlocking mechanism of the wheel 2 comprises a lever 8 as has just been indicated, this lever 8 being mounted to pivot on one of the half-shells 5a and having a lug 82 intended to mesh with a toothed wheel 21 integral in rotation with the axis of rotation of the wheel 2, the lever 8 engaging with this toothed wheel 21 so as to lock the wheel 2 in the manner shown in FIG. 5.

It is noted that the locking/unlocking mechanism of the wheel 2 comprises a spring 83 combined with the lever 8 in such a way that the spring 83 works in compression when the lever 8 is in a locking position.

The operation of the whole locking/unlocking device of the wheels 1 and 2, and of the associated controls, will now be clarified with reference to FIGS. 2 to 5.

According to an initial position shown in FIGS. 2 and 3, the levers 7 and 8 are disengaged from the toothed wheels 11 and 21 respectively, the pushchair being consequently in the non-locked position.

When the pedal 3 is activated, in other words pushed downwards, it presses against the thrust imparted by the spring 32 to the lever 7 and causes it to pivot downwards as well. The surfaces of the pedal 3 and of the lever 7 in contact with each other slide over each other on account of the respective pivoting movements of the pedal and lever, until the catch 31 of the pedal 3 engages in the indentation 72 of the lever 7, the latter then retaining the pedal 3 in the position shown in FIG. 4.

At the same time, the pivoting of the lever 7 causes its lug 71 to engage in one of the slots of the toothed wheel 11, causing the wheel 1 to lock.

In parallel, the pivoting of the lever 7 causes the cable 6 to slide inside the sheath 62, equivalent to it moving from the wheel 2 towards the wheel 1.

Consequently, at the level of the wheel 2, the lever 8 pivots against the thrust imparted by the spring 83, so that the lug 82 it presents meshes with one of the slots on the toothed wheel 21, causing the wheel 2 to lock, simultaneously, or almost, with that of the wheel 1.

The wheels 1 and 2 are unlocked in the following way.

By pressing on the pedal 4 integral with the lever 7, the latter pivots downwards moving away from the pedal 3 until the catch 31 disengages from the indentation 72 of the lever 7. The pedal 3 is no longer held by the lever 7, and only the thrust of the spring 32 is exerted on the pedal 3, causing it to return to an unlocking position.

In parallel, since the lever 7 is no longer constrained in position by the pedal 3 (and insofar as the action on the pedal 4 is released), the cable 6 is free to move, its movement being caused, on the side of the wheel 2, by the spring 83 which pushes the lever 8 back to its unlocking position. The sliding of the cable 6 is then equivalent to a movement of the wheel 1 towards the wheel 2, the cable 6 consequently pulling, by means of its lug 61, the lever 7 upwards (to the position shown in FIG. 2) and causing the wheel 1, and simultaneously, or quasi-simultaneously, the wheel 2 to unlock.

According to another characteristic of the invention, the pushchair wheels are supported cantilevered by the frame, with no axle or cross tie between them, as clearly shown in FIG. 1.

It is noted that the wheels cited in the present description are preferentially the rear wheels of the pushchair according to its direction of travel, in other words those on the side of the pushchair handlebar. It will be remembered furthermore that the term “wheel” encompasses the case of a block of two (or more) wheels.

However, the cantilevered wheel assembly that will now be described may relate both to the front wheels and to the rear wheels.

To obtain such an assembly, the axis of rotation of the wheels is supported by a mechanically welded clevis 9, angled so as to extend from the axis of rotation of the wheels to the corresponding connection branch, then coaxially to it.

A sleeve 91 is mounted at the end of each connection branch, the clevis 9 and this sleeve 91 being provided and mounted to be able to slide one in the other, this sliding being furthermore guided by a bushing 92 held in housings provided for this purpose in the half-shells 5a and 5b.

It is noted that the sleeve 91 has a truncated cone-shaped portion (a shoulder may also be suitable according to another conceivable embodiment) forming a support surface for a spring 93 forming a damper, the other end of this spring being in support on the bushing 92 and/or on the half-shells 5a, 5b.

Although the present invention has been described with reference to preferred embodiments, workers skilled in the art will recognize that changes may be made in form and detail without departing from the spirit and scope of the invention.

What is claimed is:

1. A pushchair comprising a frame carried by at least three wheels, at least two of the wheels being mounted on opposite sides of the frame, locking/unlocking means being provided on each of the two wheels and being connected to each other so as to act simultaneously,
characterised in that locking/unlocking means comprises locking control means and unlocking control means distinct from the locking control means, the locking control means and the unlocking control means being mounted in proximity to the respective wheel.

2. The pushchair according to claim 1, characterised in that it comprises retention means for retaining the locking control means in a locked position, and in that the unlocking control means act on the retention means to unlock the wheels.

3. The pushchair according to claim 2, characterised in that the retention means engage with transmission means for transmitting the locking/unlocking of the wheel in proximity to which the locking control means and the unlocking control means are mounted to the second of the two wheels.

4. The pushchair according to claim 3, characterised in that the transmission means act on a second pivoted lever mounted in proximity to the second wheel, the second pivoted lever carrying at least one lug to mesh with at least one toothed wheel integral with the axis of rotation of the second wheel to lock it.

5. The pushchair according to claim 2, characterised in that it comprises a first pedal having at least one locking catch to engage the retention means, and a second pedal which, when activated, disengages the locking catch from the retention means.

6. The pushchair according to claim 2, characterised in that the locking control means are combined with recall means tending to return the locking control means into an unlocking position.

7. The pushchair according to claim 5, characterised in that the retention means comprise a pivoted lever that has an indentation forming a housing for the catch of the first pedal.

8. The pushchair according to claim 7, characterised in that the pivoted lever carries means of locking the wheel in proximity to which the locking control means and the unlocking control means are mounted.

9. The pushchair according to claim 8, characterised in that the pivoted lever carries at least one lug able to mesh with at least one toothed wheel integral with the axis of rotation of the wheel.

10. The pushchair according to claim 5, characterised in that the first pedal is mounted to pivot on the frame.

11. The pushchair according to claim 3, characterised in that the transmission means comprise at least one cable one end of which carries a stud held in a housing of the pivoted lever.

12. The pushchair according to claim 4, characterised in that the second lever is combined with recall means tending to return the second lever to the unlocking position.

13. The pushchair according to claim 1, characterised in that the rear wheels and/or the front wheels are each carried by a clevis of cantilevered construction on the frame, in the absence of an axle between them.

14. The pushchair according to claim 13, characterised in that the devises are mounted to slide freely on the corresponding connection branch of the frame or on a part integral with this connection branch.

15. The pushchair according to claim 14, characterised by the inclusion of load damper means placed on the slide path of the devises relative to the connection branches or to the parts integral with them.

16. The pushchair according to claim 14, characterised by the inclusion of a bushing for guiding the sliding of the clevis relative to the connection branch or to the part integral with it.

17. The pushchair according to claim 16, characterised in that the bushing is integral with a shell enclosing the clevis at least partially.

18. The pushchair according to claim 17, characterised in that the shell also encloses the locking means and/or supports the locking or unlocking control means.

19. The pushchair according to claim 15, characterised in that the damper means are mounted between the bushing or the shell and a truncated cone-shaped portion of the connection branch or of a part integral with it.

20. The pushchair according to claim 3, characterised in that it comprises a first pedal having at least one locking catch to engage the retention means, and a second pedal which, when activated, disengages the locking catch from the retention means.
